(19) United States
(12) Patent Application Publication
(10) Pub. No.: US 2018/0093750 A1
(43) Pub. Date: Apr. 5, 2018

(54) PUFFING PROPULSION FOR SUPER PRESSURE BALLOONS

(71) Applicant: The Boeing Company, Chicago, IL (US)

(72) Inventor: Charles R. Svoboda, JR., Hazelwood, MO (US)

(21) Appl. No.: 15/286,441

(22) Filed: Oct. 5, 2016

(51) Int. Cl. B64B 1/62; B64B 1/70; B64B 1/64

(52) U.S. Cl. CPC B64B 1/62; B64B 1/70; B64D 2221/00; B64D 2211/00; B64B 1/64

(57) ABSTRACT

Systems and methods according to one or more embodiments are provided for a super pressure balloon puffing propulsion system that provides for directional control of the balloon. In one example, a system includes a lift gas envelope and a ballonet coupled within the lift gas envelope. The system also includes a pump used to pump a ballast gas into the ballonet. The system further includes a plurality of exhaust ports disposed around a circumference of the lift gas envelop, where the exhaust ports discharge the ballast gas from the ballonet to provide a selective horizontal propulsive force.

### TECHNICAL FIELD

The present invention relates generally to balloons, and more particularly, to directional control of super pressure balloons.

### BACKGROUND

In the field of balloons, particularly in high altitude applications, there is an ongoing effort to provide for an improved approach to directional control. For example, many high altitude balloons rely on prevailing high altitude winds to provide for directional control and propulsion. A balloon operator may, for example, increase or decrease an altitude of a balloon to where winds are blowing in a desired direction to provide for directional control and propulsion. However, during certain times of the year, especially during the spring or fall equinox periods, high altitude winds may be reduced in intensity making balloon navigation difficult.

Some conventional techniques used in balloon navigation may rely on additional propulsion components. Additional propulsion components may be used to provide directional control of a balloon until a prevailing wind stream provides the desired directional propulsion. Unfortunately, additional propulsion components add complexity and weight resulting in an increase in cost and size to an existing balloon design.

### SUMMARY

Systems and methods are disclosed herein in accordance with one or more embodiments that provide an improved approach to directional control of high altitude super pressure balloons. A puffing propulsion system provides for directional control by discharging a ballast gas through exhaust ports from a ballonet formed within a lift gas envelope. In one embodiment, the discharged ballast gas may be used to nudge a balloon in a desired horizontal direction. In one example, multiple exhaust ports may be located around the circumference of the lift gas envelope to provide a horizontal propulsive force by way of the discharged ballast gas. An exhaust port controller selectively operates the exhaust ports to provide a selective horizontal direction control of the balloon by way of the discharged ballast gas.

In one embodiment, a system includes a lift gas envelope configured to control an altitude of a balloon; a ballonet coupled within the lift gas envelope; at least one pump configured to pump a ballast gas into the ballonet; and a plurality of exhaust ports, disposed on the lift gas envelope, configured to discharge the ballast gas from the ballonet to provide a selective horizontal propulsive force.

In another embodiment, a method includes pumping, by at least one pump, a ballast gas into a ballonet of a lift gas envelope; controlling an intake of the ballast gas into the ballonet; and discharging, by one or more exhaust ports disposed on the lift gas envelope, the ballast gas from the ballonet to provide a selective horizontal propulsive force to a balloon.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a puffing propulsion system implemented with various exhaust ports secured to a lift gas envelope of a balloon in accordance with an embodiment of the disclosure.

FIG. 2 illustrates a block diagram of a puffing propulsion system in accordance with an embodiment of the disclosure.

FIG. 3 illustrates an exhaust ports controller, various exhaust ports, a pump, and a pump valve controller of a puffing propulsion system in accordance with an embodiment of the disclosure.

FIG. 4 illustrates an elevation view of an exhaust port in accordance with an embodiment of the invention.

FIG. 5 illustrates a process of using a puffing propulsion system in accordance with an embodiment of the disclosure.

### DETAILED DESCRIPTION

Various implementations of a puffing propulsion system are provided to assist in navigation of a high altitude super pressure balloon. The puffing propulsion system includes a ballonet of a lift gas envelope, a pump, and multiple exhaust ports distributed around a circumference of the lift gas envelope. In various embodiments, the pump operates to pump a ballast gas into the ballonet to control an altitude of the balloon. A balloon operator may change an altitude of the balloon to catch a prevailing wind blowing in a desired direction. However, during certain times of the year, winds may be absent at any given altitude. In this regard, a propulsion assist may be required to provide directional control of the balloon.

In some embodiments, the ballonet may discharge the ballast gas through one or more of the exhaust ports distributed around the circumference of the lift gas envelope to provide a horizontal propulsive force. The horizontal propulsion provides a nudging force to the balloon to move the balloon in a desired direction. One or more exhaust ports may be operated to provide a selective horizontal directional control. In some embodiments, operating all exhaust ports simultaneously provides for a vertical descent of the balloon.

In general, the puffing propulsion system provides for horizontal control to nudge a high altitude balloon in a desired direction. By locating exhaust ports around the circumference of the lift gas envelope, the puffing propulsion system takes advantage of existing altitude control components to provide for horizontal propulsion. Implementation of the puffing propulsion system provides for directional control when high altitude prevailing winds are unpredictable or reduced in intensity.

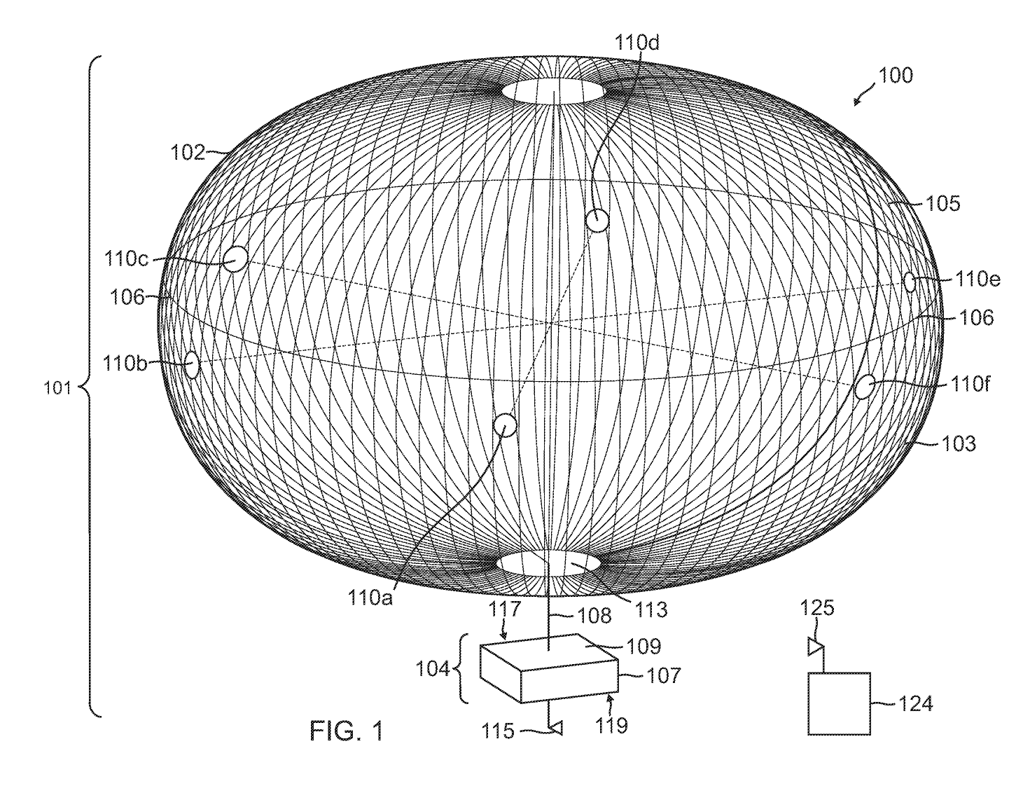

FIG. 1 illustrates a puffing propulsion system 100 implemented with various exhaust ports 110 secured to a lift gas envelope 102 of a balloon 101 in accordance with an embodiment of the disclosure. As shown in FIG. 1, puffing propulsion system 100 is included as part of balloon 101. Balloon 101 includes lift gas envelope 102, a ballonet 103, a controls electronics 104, and a lift gas chamber 105. In various embodiments, lift gas envelope 102 is separated into a lower compartment and an upper compartment by a diaphragm 106 fixably sealed to an inner wall of lift gas envelope 102. In some embodiments, diaphragm 106 is sealed at a circumferential edge of lift gas envelope 102 to sealably separate the lower and upper compartments. In some embodiments, the lower compartment is ballonet 103 and the upper compartment is lift gas chamber 105.

In some embodiments, lift gas chamber 105 includes a low density gas such as helium to provide a lift to balloon 101. In this regard, as balloon 101 increases altitude, the helium within lift gas chamber 105 expands creating a buoyancy force. The expanding helium fills lift gas chamber 105 until lift gas chamber 105 stretches and resists the expansion of the helium. At that point, the buoyancy force is zero and balloon 101 becomes neutrally buoyant.

In some embodiments, ballonet 103 is filled with a ballast gas 113. In various embodiments, ballast gas 113 is atmospheric air which has a higher density than helium. However, other embodiments are possible such as an inert gas (e.g., also with a higher density than helium), for example. Ballonet 103 may be filled with atmospheric air to provide an altitude control of balloon 101. For example, as air is pumped into ballonet 103 through ballonet intake tube 108, helium is displaced in lift gas chamber 105 and balloon 101 begins to decrease in altitude. As air is discharged from ballonet 103 through exhaust ports 110a-f, balloon 101 begins to increase in altitude. Significantly, an altitude of balloon 101 is controlled by pumping ballast gas 113 into ballonet 103 and discharging ballast gas 113 from ballonet 103 through exhaust ports 110.

As shown in FIG. 1, in various embodiments, exhaust ports 110a-f are disposed on an outside surface of lift gas envelope 102. In some embodiments, six exhaust ports may be distributed around a circumference of lift gas envelope 102. However, fewer or more exhaust ports 110 are possible in other embodiments. Exhaust ports 110a-f are in communication with ballonet 103 such that ballonet 103 directly discharges ballast gas 113 through exhaust ports 110. In this regard, a selective horizontal propulsive force is provided by locating exhaust ports 110 around a circumference of lift gas envelope 102 and discharging ballast gas 113 through exhaust ports 110a-f. Significantly, by locating exhaust ports 110 around the circumference of lift gas envelope 102, system 100 takes advantage of existing altitude control components such as ballonet 103 and exhaust ports 110 to provide for horizontal propulsion control.

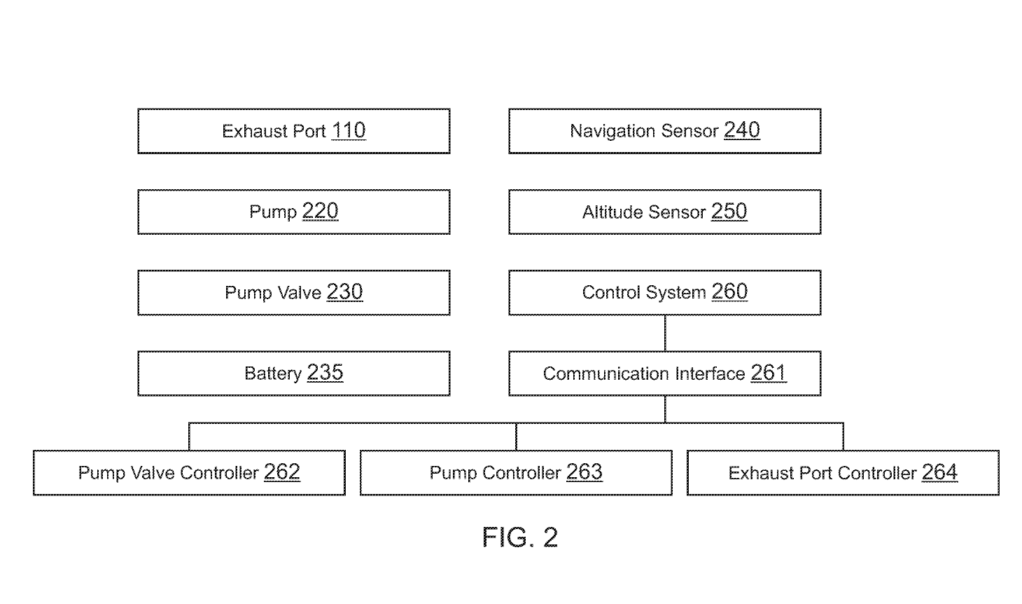

In some embodiments, balloon 101 includes controls electronics 104 provided in a housing 107. In some embodiments, controls electronics 104 includes electronics for balloon 101 power, altitude control, and system 100, as discussed herein. In some embodiments, housing 107 may be a metallic or a rigid plastic housing. Housing 107 may be insulated, and waterproofed to provide environmental protection. In some embodiments, a solar collection device 109 may be included on a top surface 117 of housing 107. Solar collection device 109 may be implemented to convert photonic energy into electricity to provide an electrical charge to a battery (e.g., such as battery 235 of FIG. 2), as discussed herein. In some embodiments, system 100 includes an antenna 115. Antenna 115 may be included on a bottom surface 119 of housing 107. Antenna 115 may be in communication with a balloon control facility antenna 125 to provide a communication link between system 100 and a balloon control facility 124.

FIG. 2 illustrates a block diagram of system 100 in accordance with an embodiment of the disclosure. System 100 may be used to provide a puffing propulsion to assist in navigational control of balloon 101. In one embodiment, various components of system 100 may be included within housing 107. Housing 107 provides a protective enclosure.

In one embodiment, system 100 includes multiple exhaust ports 110, a pump 220, a pump valve 230, a battery 235, a navigation sensor 240, an altitude sensor 250, and a control system 260. In various embodiments, system 100 may be implemented with components used to control an altitude of balloon 101. For example, exhaust ports 110, pump 220, pump valve 230, battery 235, navigation sensor 240, altitude sensor 250, and control system 260 may be shared between system 100 and an altitude control system.

In various embodiments, exhaust port 110 is implemented to provide a horizontal propulsive force to balloon 101. In some embodiments, exhaust port 110 is disposed on an outside circumferential surface of lift gas envelope 102 and is coupled to ballonet 103, as discussed herein. In some embodiments, exhaust port 110 is selectively operated by exhaust ports controller 264 where exhaust port 110 provides a propulsive force to ballast gas 113 discharged from exhaust port 110. In this regard, exhaust port 110 provides a horizontal directional control of balloon 101.

In some embodiments, pump 220 is implemented to provide ballast gas 113 to ballonet 103. Pump 220 may pump ballast gas 113 into ballonet 103 to fill ballonet 103. In some embodiments, pump 220 may fill ballonet 103 to an atmospheric pressure slightly greater than a pressure outside lift gas envelope 102 to maintain a positive pressure within ballonet 103. Maintaining a positive pressure inside ballonet 103 provides for a propulsive force when ballast gas 113 is discharged from one or more exhaust ports 110 into the atmosphere. In some embodiments, system 100 includes a pump valve 230 implemented to provide a control of ballast gas 113 to ballonet 103 and to maintain a positive atmospheric pressure. In this regard, pump valve 230 is opened while pump 220 is pumping ballast gas 113 into ballonet 103 and pump valve 230 is closed while pump 220 is idle. Operation of pump 220 and pump valve 230 may be controlled by control system 260, as discussed herein.

In some embodiments, battery 235 is implemented as a direct current (DC) battery to provide DC power to various components of system 100. For example, battery 235 may provide DC power to pump 220, pump valve 230, navigation sensor 240, altitude sensor 250, and various components of control system 260. In various embodiments, solar collection device 109 is electrically coupled to battery 235 to provide battery 235 with an electrical charge.

In some embodiments, navigation sensor 240 is implemented to provide a present orientation of exhaust ports 110. In various embodiments, navigation sensor 240 is implemented as a compass and provides an electrical signal with present orientation data to control system 260. However, other navigational positioning devices are possible, such as a global positioning system (GPS) device, a global navigation satellite system (GNSS) device, an automatic packet reporting system (APRS) device or other type of geographic position location systems. In some embodiments, altitude sensor 250 provides an altitude of balloon 101. In this regard, altitude sensor 250 may be implemented as an altimeter and provides an electrical signal with altitude data to control system 260. In other embodiments, altitude sensor 250 may be implemented as a global positioning system (GPS) device.

In one embodiment, control system 260 is implemented as a processor, and may include, for example, a microcontroller, a field programmable gate array (FPGA), a digital signal processing (DSP) device, one or more memories for storing executable instructions (e.g., software, firmware, or other instructions), and/or any other appropriate combination of processing device and/or memory to execute instructions to perform any of the various operations described herein. Control system 260 is adapted to interface and/or communicate with components 220, 230, 235, 240, 250, 261, 262, 263, and 264 to perform method and processing steps as described herein.

Control system 260 may be adapted to receive electrical signals from navigation sensor 240 and altitude sensor 250, and store sensor signals (e.g., sensor 240 and 250 signals). In some embodiments, control system 260 is adapted to process sensor signals to provide navigational and altitude data to communication interface 261 for transmission to balloon control facility 124. In some embodiments, control system 260 is adapted to process sensor signals and execute instructions to provide control signals to a pump valve controller 262, a pump controller 263 and an exhaust ports controller 264 to perform method and processing steps as described herein.

In various embodiments, communication interface 261 may include one or more wired or wireless communication components, such as an Ethernet connection, a wireless local area network (WLAN) component based on the IEEE 802.11 standards, a wireless broadband component, or various other types of wireless communication components including radio frequency (RF), microwave frequency (MWF), and/or infrared frequency (IRF) components adapted for communication with battery 235, navigation sensor 240, altitude sensor 250, control system 260, pump valve controller 262, pump controller 263, and exhaust ports controller 264. Communication interface 261 may be coupled to antenna 115 for wireless communication to various components of system 100, and balloon control facility 124.

In some embodiments, pump valve controller 262 is implemented to control pump valve 230 in response to an electrical signal from control system 260. In this regard, pump valve controller 262 provides an electrical signal to open pump valve 230 to allow ballast gas 113 to flow from pump 220 to ballonet 103. Pump valve controller 262 provides an electrical signal to close pump valve 230 to prevent leakage of ballast gas 113 from ballonet 103 to pump 220. In various embodiments, pump controller 263 controls operation of pump 220 in response to an electrical signal from control system 260.

In various embodiments, exhaust ports controller 264 is implemented to control exhaust ports 110 to selectively open and/or close exhaust ports 110 in response to an electrical signal from control system 260. For example, exhaust ports controller 264 may respond to a control system 260 electrical signal (e.g., a serial command signal) to open one or more exhaust ports 110. In this regard, system 100 takes advantage of existing altitude control components to provide for selective horizontal directional control. Additionally, for example, exhaust ports controller 264 may respond to a control system 260 electrical signal to open all exhaust ports 110 to initiate a vertical descent of balloon 101.

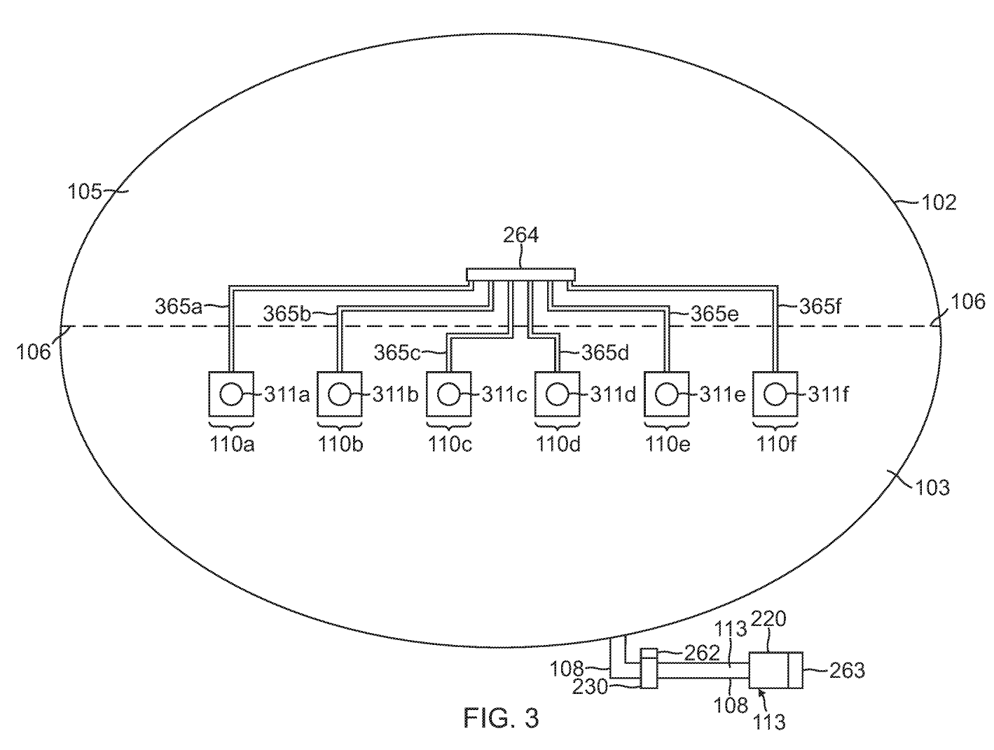

FIG. 3 illustrates an exhaust ports controller 264, various exhaust ports 110, a pump 220, and a pump valve controller 262 of a system 100 in accordance with an embodiment of the disclosure. As shown in FIG. 3, lift gas envelope 102 is separated into ballonet 103 (e.g., at a lower portion of lift gas envelope 102) and lift gas chamber 105 (e.g., at an upper portion of lift gas envelope 102) by diaphragm 106. Diaphragm 106 is fixably sealed to an inner wall of lift gas envelope 102. In various embodiments, diaphragm 106 is sealed at a circumferential edge of lift gas envelope 102 to sealably separate ballonet 103 from lift gas chamber 105.

In the embodiment shown in FIG. 3, six exhaust ports 110a-f are distributed around a circumference of lift gas envelope 102. It is understood, fewer or more exhaust ports 110 may be distributed around lift gas envelope 102. Each of exhaust ports 110a-f are located within the lower portion of lift gas envelope 102. In this regard, convergent nozzles 311a-f of exhaust ports 110a-f, respectively, are fixably attached to lower portion of lift gas envelope 102 and in communication with ballonet 103 to discharge ballast gas 113 from ballonet 103.

FIG. 3 includes, in one embodiment, pump 220 mechanically coupled to ballonet 103 through ballonet intake tube 108. Pump valve 230 is adapted to control the flow of ballast gas 113 from pump 220 into ballonet 103. Pump valve 230 is controlled by pump controller 262 where pump controller 262 selectively opens and closes pump valve 230 in response to control system 260 commands, as discussed herein. Pump controller 263 operates pump 220 in response to control system 260 commands to fill ballonet 103 with ballast gas 113. In some embodiments, altitude of balloon 101 is decreased by filling ballonet 103 with ballast gas 113. In addition, pump 220 fills ballonet 103 with an amount of ballast gas 113 to maintain a positive atmospheric pressure of ballast gas 113. In this regard, a positive atmospheric pressure provides for a horizontal propulsive force when ballast gas 113 discharges through exhaust ports 110 during horizontal directional maneuvering.

As shown in FIG. 3, exhaust ports controller 264 is electrically connected to each of exhaust ports 110a-f via wired connections 365a-f, respectively. In some embodiments, exhaust ports controller 264 is wirelessly coupled to exhaust ports 110a-f, as discussed herein. Exhaust ports controller 264 is adapted to selectively operate one or more exhaust ports 110a-f in response to control system 260 commands to provide for horizontal directional control, as discussed herein.

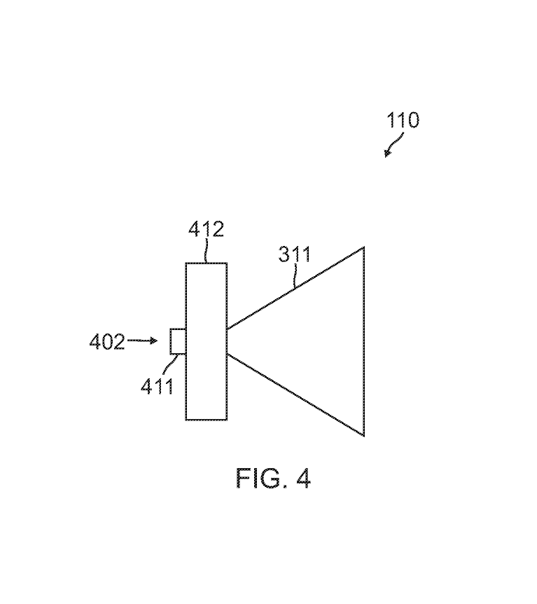

FIG. 4 illustrates an elevation view of an exhaust port 110 in accordance with an embodiment of the invention. As shown in FIG. 4, exhaust port 110 includes convergent nozzle 311, a ballast gas intake tube 411, and an exhaust port valve 411. Exhaust port 110 is mechanically coupled to lift gas envelope 102 and convergent nozzle 311 is fixably attached to an outside surface of lift gas envelope 102, as discussed herein. In some embodiments, exhaust port 110 is in communication with ballast gas 113 within ballonet 103 at ballast gas intake tube 411. Ballast gas 113 from ballonet 103 flows in a direction 402 from ballast gas intake tube 411, through exhaust port valve 412, and through convergent nozzle 311 into the atmosphere. Exhaust port valve 412 is electrically coupled to exhaust ports controller 264.

Exhaust ports controller 264 selectively opens and closes exhaust port valve 412 to control the flow of ballast gas 113 through exhaust port 110. In this regard, ballast gas 113 flows through exhaust port 110 in a direction of 402 when exhaust port valve 412 is open. Conversely, there is no flow of ballast gas 113 when exhaust port valve 412 is closed.

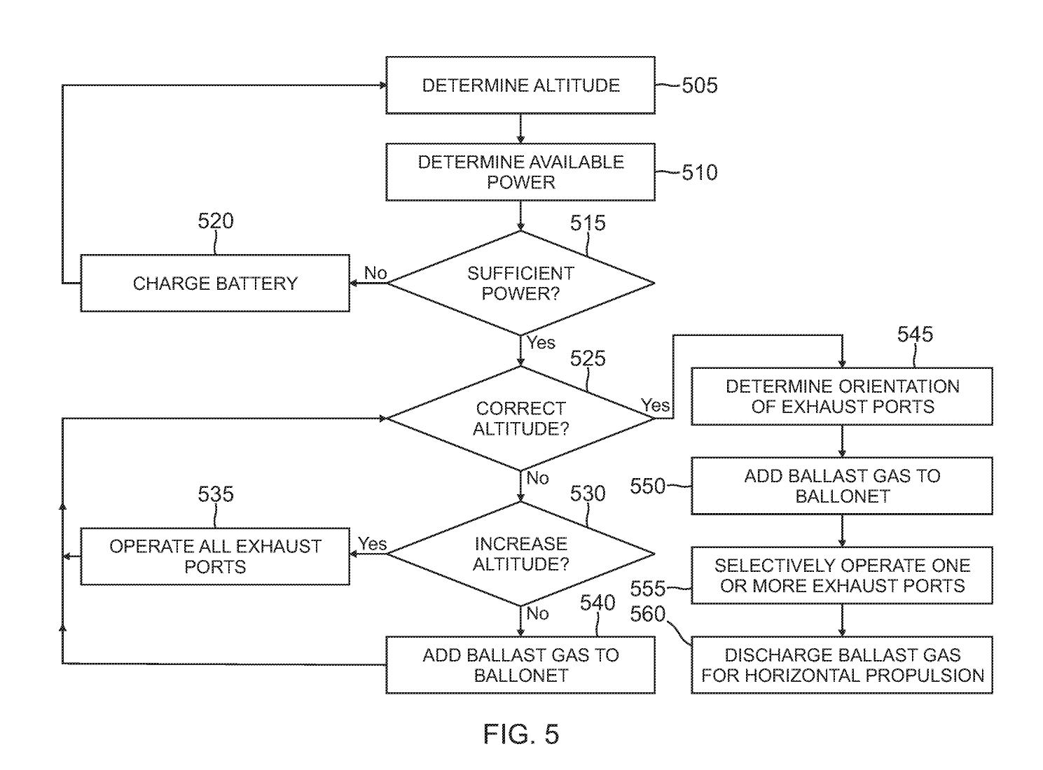

FIG. 5 illustrates a process of using a system 100 in accordance with an embodiment of the disclosure.

In block 505, control system 260 receives altitude data from altitude sensor 250 to determine a current altitude of balloon 101. In some embodiments, control system 260 communicates altitude data to balloon control facility 124 via communication interface 261.

In block 510, control system 260 receives battery power data from battery 235 to determine available DC power for performing altitude and horizontal propulsion operations.

In block 515, control system 260, using the battery 235 power data provided in block 510, determines if sufficient power is available to power various components of system 100, for example, pump 220, pump valve 230, pump valve controller 262, pump controller 263, exhaust ports 110, and exhaust ports controller 264. If it is determined there is not sufficient battery 235 power available, the process may proceed to block 520 where solar collection device 109 charges battery 235. After battery 235 has been charged, the process may return to block 505 where control system 260 receives altitude data from altitude sensor 250 to determine a current altitude of balloon 101 and block 510 where control system 260 receives battery power data from battery 235 to determine available DC power. If it is determined there is sufficient battery 235 power, the process proceeds to block 525.

In block 525, in some embodiments, balloon control facility 124 may communicate to control system 260 via communication interface 261 if balloon 101 is at the correct altitude. In other embodiments, control system 260 may determine, using altitude data of block 505 and pre-programmed parameters, if balloon 101 is at the correct altitude.

If balloon 101 is not at the correct altitude, the process may proceed to block 530 where, based on control system 260 pre-programmed parameters and/or balloon control facility 124 commands transmitted by way of communication interface 261, it is determined if altitude of balloon 101 needs to be increased or decreased.

If altitude of balloon 101 needs to increase, the process may proceed to block 535 where control system 260 transmits a signal to exhaust ports controller 264 to operate all exhaust ports 110a-f. In this regard, exhaust ports controller 264 transmits a signal to each exhaust port valve 412 to open and allow ballast gas 113 to discharge through exhaust ports 110a-f for a determinate period of time until the desired altitude is reached.

If altitude of balloon 101 needs to decrease, the process may proceed to block 540 where control system 260 transmits signals to pump valve controller 262 and pump controller 263 to open pump valve 230 and turn on pump 220, respectively. In this regard, ballast gas 113 is added to ballonet 103 from pump 220 through ballonet intake tube 108 for a determinate period of time until the desired altitude is reached.

If it is determined altitude of balloon 101 is correct, the process may proceed to block 545 where control system 260 receives exhaust port 110 orientation data from navigation sensor 240. In some embodiments, control system 260 communicates orientation data to balloon control facility 124 via communication interface 261. In other embodiments, control system 260 processes orientation data to determine an orientation of exhaust ports 110.

In block 550, ballast gas 113 may be added to ballonet 103 (e.g., similar to block 540) to provide for a positive pressure within ballonet 103. Providing a positive pressure of ballast gas 113 within ballonet 103 makes certain a propulsive force when ballast gas 113 is discharged from one or more exhaust ports 110 during puffing propulsion maneuvers.

In block 555, control system 260 selectively operates one or more exhaust ports 110 to provide a directional control of balloon 101. For example, in one embodiment, control system 260 may, based on orientation data received from navigation sensor 240, determine one or more exhaust ports 110 should be opened to provide the desired directional control of balloon 101. In another embodiment, control system 260 may receive commands from balloon control facility 124 to open one or more exhaust ports 110 to provide the desired directional control.

In block 560, control system 260 transmits a signal to exhaust ports controller 264 to operate one or more exhaust ports 110a-f selected in block 555. In this regard, exhaust ports controller 264 transmits a signal to each of the selected exhaust port valves 412 to open and allow ballast gas 113 to discharge through selected exhaust ports 110a-f for a determinate period of time until the desired directional control is achieved.

In view of the present disclosure, it will be appreciated that providing system 100 in accordance with various embodiments set forth herein may provide for horizontal propulsion of a balloon by utilizing exhaust ports disposed on a horizontal circumferential outside surface of a lift gas envelop of the balloon. By locating exhaust ports around the circumference of lift gas envelope, system 100 takes advantage of existing altitude control components such as a ballonet and exhaust ports to provide for horizontal propulsion control. In this regard, by determining an orientation of exhaust ports, adding ballast gas to the ballonet, selectively operating one or more of the horizontal circumferentially located exhaust ports, and discharging the ballast gas through the one or more exhaust ports, a lightweight, low cost alternative to adding a standalone horizontal propulsion system may be implemented for high altitude super pressure balloons.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A system comprising:
a lift gas envelope configured to control an altitude of a balloon;
a ballonet coupled within the lift gas envelope;
at least one pump configured to pump a ballast gas into the ballonet; and
a plurality of exhaust ports, disposed on the lift gas envelope, configured to discharge the ballast gas from the ballonet to provide a selective horizontal propulsive force.

2. The system of claim 1, wherein:
the exhaust ports are disposed on an outside surface of the lift gas envelope;
the exhaust ports are distributed around a circumference of the lift gas envelope; and
the exhaust ports are in communication with the ballonet.

3. The system of claim 1, wherein each of the plurality of exhaust ports comprises:
a convergent nozzle fixably attached to an outside surface of the lift gas envelope and configured to form an exhaust port opening; and
an exhaust port valve coupled to the nozzle and configured to control the ballast gas discharge.

4. The system of claim 3, further comprising an exhaust port controller, wherein the exhaust port controller selectively operates the exhaust port valve of each exhaust port to provide a selective horizontal directional control of the balloon by the discharged ballast gas.

5. The system of claim 4, wherein the exhaust port controller operates the exhaust port valve of all exhaust ports to provide a vertical control of the balloon by the discharged gas.

6. The system of claim 1, further comprising a navigation sensor coupled to the balloon to provide a present orientation of the exhaust ports.

7. The system of claim 1, further comprising at least one pump valve coupled between the at least one pump and the ballonet, and configured to provide a flow control of the ballast gas to the ballonet to maintain a positive atmospheric pressure within the ballonet.

8. The system of claim 7, further comprising a pump valve controller, wherein the pump valve controller operates the at least one pump valve to selectively couple the at least one pump to the ballonet.

9. The system of claim 1, further comprising a lift gas chamber separated from the ballonet by a diaphragm sealably coupled to an inner wall of the lift gas envelope at a circumferential edge.

10. The system of claim 1, wherein the ballast gas is atmospheric air, and/or an inert gas.

11. The system of claim 1, further comprising a battery configured to provide a direct current (DC) power supply to the system, wherein the battery is electrically coupled to a solar collection device, and wherein the solar collection device provides an electrical charge to the battery.

12. A method of using the system of claim 1, the method comprising:
pumping, by the pump, the ballast gas into the ballonet; and
discharging, by one or more of the plurality of exhaust ports, the ballast gas to provide the selective horizontal propulsive force.

13. A method of assembling the system of claim 1, the method comprising:
coupling the ballonet within the lift gas envelope;
coupling the at least one pump to the ballonet; and
disposing the plurality of exhaust ports on the lift gas envelope, wherein the plurality of exhaust ports are distributed around a circumference of the lift gas envelope.

14. A method comprising:
pumping, by at least one pump, a ballast gas into a ballonet of a lift gas envelope;
controlling an intake of the ballast gas into the ballonet; and
discharging, by one or more exhaust ports disposed on the lift gas envelope, the ballast gas from the ballonet to provide a selective horizontal propulsive force to a balloon.

15. The method of claim 14, wherein the discharging comprises disposing the exhaust ports on an outside surface of the lift gas envelope, and distributing the exhaust ports around a circumference of the lift gas envelope, wherein the exhaust ports are in communication with the ballonet.

16. The method of claim 14, wherein the discharging further comprises:
fixably attaching a convergent nozzle to an outside surface of the lift gas envelope to form an exhaust port opening; and
coupling an exhaust port valve to the convergent nozzle to control the ballast gas discharge.

17. The method of claim 14, wherein the discharging comprises:
selectively operating one or more exhaust ports to provide a selective horizontal directional control of the discharged ballast gas; and
operating all exhaust ports to provide a vertical descent of the balloon.

18. The method of claim 14, further comprising determining a present orientation of the exhaust ports.

19. The method of claim 14, wherein the pumping comprises:
selectively coupling the pump to the ballonet;
pumping atmospheric air and/or an inert gas into the ballonet; and
wherein the controlling comprises maintaining a positive atmospheric pressure within the ballonet.

20. The method of claim 14, further comprising providing, by a battery, a direct current (DC) power supply to the system, and electrically charging, by a solar energy collection device, the battery.
